(19) United States
(12) Patent Application Publication
(10) Pub. No.: US 2014/0082305 A1
(43) Pub. Date: Mar. 20, 2014

(54) PROVIDING USAGE STATISTICS FOR VIRTUAL STORAGE

(71) Applicant: International Business Machines Corporation, Amonk, NY (US)

(72) Inventors: David Hom, Poughkeepsie, NY (US); Thomas F. Rankin, Wallkill, NY (US); Elpida Tzortzatos, Lagrangeville, NY (US); Christine M. Yost, Hopewell Junction, NY (US)

(73) Assignee: International Business Machines Corporation, Amonk, NY (US)

(21) Appl. No.: 14/084,880

(22) Filed: Nov. 20, 2013

Related U.S. Application Data
(63) Continuation of application No. 13/486,020, filed on Jun. 1, 2012.

(51) Int. Cl. G06F 12/10; G06F 3/06

(52) U.S. Cl. CPC G06F 12/1027; G06F 3/0604
USPC 711/156

(57) ABSTRACT

A method for obtaining a measurement of storage usage includes sending a request, by a processor, for the measurement of storage usage during execution of an application by the processor; counting blocks of storage to generate the measurement of storage usage by the application; and providing the measurement of storage usage to the application.

### CROSS-REFERENCE TO RELATED APPLICATION

This application is a continuation of U.S. patent application Ser. No. 13/486,020, filed Jun. 1, 2012, the disclosure of which is incorporated by reference herein in its entirety.

### BACKGROUND

Embodiments relate generally to storage management in computing systems, and in particular to providing usage statistics for virtual storage above a predefined limit.

Existing computing systems providing 64 bit addressing (e.g., servers executing the z/OS® operating system) provide above the bar virtual storage availability of 16 exabytes (EB), or 2⁶⁴ bytes, of data to applications running on system. (The “bar” here refers to the limitation of a predecessor architecture, which had only 24 address bits and a maximum address space size of 16 megabytes (MB).) The applications' use and reference to this storage results in the consumption of real storage and auxiliary storage. Real storage and auxiliary storage are limited system resources defined by the hardware and paging system configurations. It is beneficial for an application to balance performance with consumption of these limited system resources.

### SUMMARY

According to an exemplary embodiment, a method for obtaining a measurement of storage usage includes sending a request from an application executing on a processor for the measurement of storage usage by the application during execution of the application; counting blocks of storage to generate the measurement of storage usage by the application; and providing the measurement of storage usage to the application.

According to another exemplary embodiment, a computer program product for obtaining a measurement of storage usage includes a computer readable storage medium having computer readable program code embodied therewith, the computer readable program code configured to implement: sending a request from an application executing on a processor for the measurement of storage usage by the application during execution of the application; counting blocks of storage to generate the measurement of storage usage by the application; and providing the measurement of storage usage to the application.

According to another exemplary embodiment, a system includes a processor executing an application, the application sending a request for the measurement of storage usage during execution of the application; and a storage manager receiving the request and counting blocks of storage to generate the measurement of storage usage by the application; the storage manager providing the measurement of storage usage to the application.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of a computing system in an exemplary embodiment;

FIG. 2 is a flowchart of a process for providing a measurement of storage usage in an exemplary embodiment; and

FIG. 3 depicts 64 bit dynamic address translation tables in an exemplary embodiment.

### DETAILED DESCRIPTION

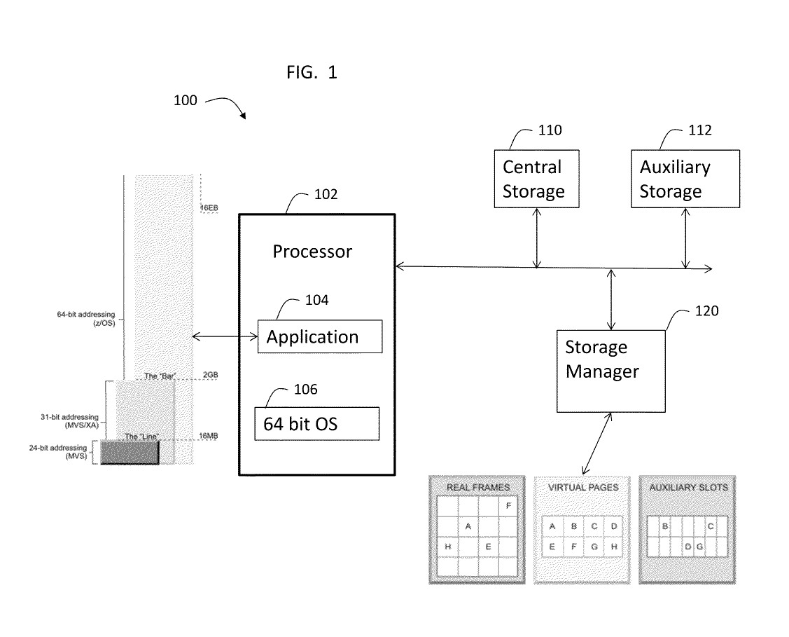

Referring to FIG. 1, a block diagram of an exemplary computing system 100 is shown. Computing system 100 includes a processor 102, which may be a single processor or a central processor complex having a plurality of processing units. The term “processor” is intended to refer to one or more processing units. In an exemplary embodiment, processor 102 is a part of a server or mainframe employing a 64-bit architecture, such as an IBM System z® mainframe. Processor 102 is a machine executing one or more applications 104 and an operating system 106. As shown illustratively in FIG. 1, the 64-bit architecture provides for above the bar virtual storage availability of 16 EB of data to applications running on computing system 100.

Processor 102 interfaces with central storage 110 and auxiliary storage 112. Central storage 110 may be memory that is located on the mainframe processor 102, or internal to the mainframe. Auxiliary storage 112 may be physical storage external to the mainframe, including storage on direct access devices such as disk drives and sequential (or serial) access devices such as tape drives. Central storage 110 may be accessed synchronously with the processor 102. Auxiliary storage 112 is accessed asynchronously. The processor 102 accesses auxiliary storage 112 through an input/output (I/O) request, which is scheduled to run amid other work requests in the system. During an I/O request, processor 102 is free to execute other, unrelated work.

A storage manager 120 manages the central storage 110 and auxiliary storage 112. Storage manager 120 may be implemented by processor 102, or one or more other processors. Storage manager 120 keeps track of the contents of central storage 110. Storage manager 120 may manage paging activities (e.g., page-in, page-out, and page stealing) and aid with swapping an address space in or out. Storage manager 120 may also use system page data sets to keep track of auxiliary storage slots in auxiliary storage 120. Storage manager 120 may also manage virtual storage by responding to requests to obtain and free virtual storage. Storage manager 120 may keep track of a map of virtual storage for each address space.

As shown in FIG. 1, the storage manager 120 manages blocks of central storage, referred to as frames, blocks of auxiliary storage referred to as slots, and blocks of virtual storage, referred to as pages. Storage manager 120 may be implemented using one or more of multiple storage managers, such as a real storage manager, auxiliary storage manager and virtual storage manager. Storage manager is used herein to generically refer to one or more of these devices.

In order for application 104 to balance performance versus consumption of central storage and auxiliary storage, application 104 may find beneficial a count of one or more of real frames, auxiliary slots and virtual pages being presently consumed. For application 104 to manage a range of address space storage, run time availability of a measurement of storage usage is provided by storage manager 120. Application 104 can then use the measurement of storage usage to more efficiently manage its data, balancing in storage data with data stored in its own files.

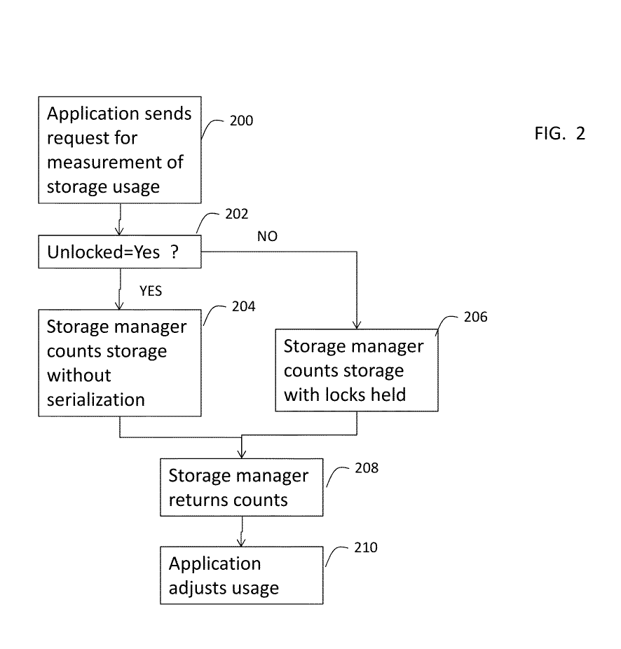

FIG. 2 is flowchart of a process for providing a measurement of storage usage to application 104 during execution on processor 102. The process begins at 200, where application 104 requests a measurement of storage usage from storage manager 120. The request may be in the form of a command, along with a requested range of addresses for which the measurement of storage usage is requested.

The application 104 may also designate whether the measurement of storage usage is to be performed without serialization. At 202, the application may request that the measurement of storage usage be performed without serialization by sending an unlock command, such as UNLOCKED=YES. When UNLOCKED=YES is coded, the storage manager locks will not be held during measurement of storage usage. As the locks are not held, the measurement of storage usage is an estimated measurement, as the storage manager 120 can be modifying storage allocations. The unlock command is useful for applications that are multi-threaded (so that obtaining locks would present a performance bottleneck to the application) when an estimated count would be sufficient. The default unlock command maintains serialization of the storage manager, and may be identified as UNLOCKED=NO.

At 204, the storage manager 120 generates the measurement of storage usage by counting blocks of storage corresponding to the number of real frames, the number of auxiliary slots and the number of pages that are consuming both real frames and auxiliary slots, for the requested range of addresses. If at 202, the unlock command is not present, the flow proceeds to 206. At 206 storage manager 120 generates the measurement of storage usage by counting blocks of storage corresponding to the number of real frames, the number of auxiliary slots and the number of pages that are consuming both real frames and auxiliary slots, for the requested range of addresses. The measurement at 206 is more accurate than at 204, as the serialization is maintained.

At 208, the storage manager 120 returns the measurement of storage usage for the requested range of addresses by providing the number of real frames, the number of auxiliary slots and the number of pages that are consuming both real frames and auxiliary slots to the application 104. At 210, application 104 may then adjust storage usage based on the measurement of storage usage. For example, if application 104 is using more than a threshold amount (e.g., 90%) of the storage identified by the range of addresses, application 104 can adjust its storage usage (e.g., delete unused pages).

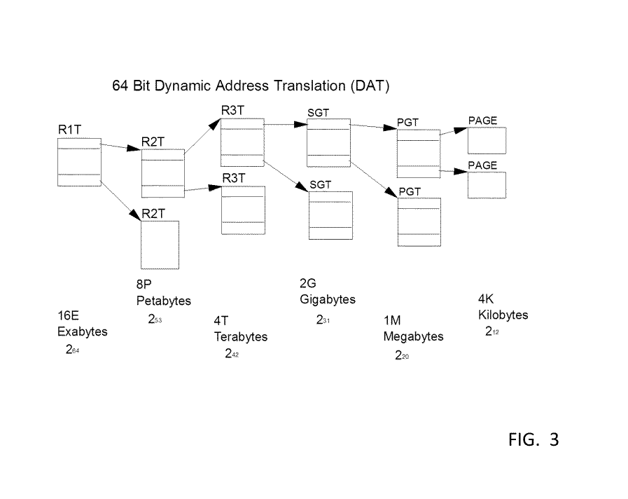

To improve the efficiency in deriving the measurement of storage usage, knowledge of the real storage management addressing control block structures can be used to skip counting blocks of storage when region tables and segment tables indicate there has been no reference to this storage. FIG. 3 illustrates dynamic address translation (DAT) tables including region-first table R1T, region-second tables R2T, region-third tables R3T, segment tables SGT, page tables PGT and pages. Storage manager 120 may access the DAT tables to more quickly determine storage usage for the requested range of addresses. For example, if a segment table entry (e.g., a page table address) corresponding to the requested range of addresses is zero, or does not exist, then the storage manager 120 knows there is 1 MB of free storage. If, however, a segment table entry (e.g., a page table address) corresponding to the requested range of addresses does exist, then the storage manager 120 will examine these addresses to determine which pages are currently in real storage and/or auxiliary storage.

Embodiments allow an application to request a measurement of storage usage when needed, without impacting system performance. This provides granular information to the application so that it can identify actions that may be needed to improve overall performance of the application. The storage manager steps through its internal control blocks to determine where each requested page currently resides and accumulate the counts. For the most accurate counts, this processing is done while holding the proper real storage serialization.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a processor executing an application, the application sending a request for a measurement of storage usage by the application during execution of the application; and
a storage manager receiving the request and counting blocks of storage to generate the measurement of storage usage by the application;
the storage manager providing the measurement of storage usage to the application.

2. The system of claim 1 wherein:
counting blocks of storage includes counting frames of central storage, counting slots of auxiliary storage and counting pages of virtual storage.

3. The system of claim 1 wherein:
the request includes an unlock command, wherein the counting blocks of storage is performed without serialization of the storage manager in response to the unlock command.

4. The system of claim 1 wherein:
counting blocks of storage includes the storage manager accessing dynamic address translation (DAT) tables to include or exclude blocks of storage from the count.
